(19) United States
(12) Patent Application Publication
(10) Pub. No.: US 2025/0340245 A1
(43) Pub. Date: Nov. 6, 2025

(54) SUPPORT FOR AN ELECTRICAL CHARGING SOCKET OF A VEHICLE

(71) Applicant: AMPERE S.A.S., Boulogne Billancourt (FR)

(72) Inventor: Lucy PHILIPPE, Guyancourt (FR)

(73) Assignee: AMPERE S.A.S., Boulogne Billancourt (FR)

(21) Appl. No.: 18/714,940

(22) PCT Filed: Nov. 14, 2022
(86) PCT No.: PCT/EP2022/081845

§ 371 Date: May 30, 2024

(30) Foreign Application Priority Data
Dec. 9, 2021 (FR) FR2113236

(51) Int. Cl. B62D 25/12; B60L 53/16

(52) U.S. Cl. CPC B62D 25/12; B60L 53/16

(57) ABSTRACT

A support is for a hinge of an opening leaf of an electric or hybrid motor vehicle that can be recharged via a charging socket. The support includes structure for retaining the charging socket with respect to the support.

### TECHNICAL FIELD OF THE INVENTION

The invention relates to a support for a hinge of a motor vehicle hood, comprising a means for retaining an electrical charging socket. The invention also relates to an arrangement comprising such a support. The invention also relates to a body comprising such an arrangement. The invention also relates to a vehicle comprising such a body, or such an arrangement, or such a support. The invention also relates to a method for assembling such a body.

### PRIOR ART

A motor vehicle of electric type, referred to as an electric vehicle (EV), or of rechargeable hybrid type, referred to as a plug-in hybrid electric vehicle (PHEV), comprises a means for storing electrical energy used to haul and/or propel such a vehicle. Such a vehicle comprises an electrical socket allowing the storage means of the vehicle to be connected to an electrical current supply. Thus, generally, a cable equipped at one end with a connector complementary to the socket equipping the vehicle, and connected to an electrical supply network at its other end, allows the transfer of electrical energy from such a network to the storage means of the vehicle.

The installation of such a socket on such a vehicle, generally at a front fender, is complex.

On the one hand, such a socket is bulky and/or requires space behind it for the passage of electrical cabling which has a considerable cross section and/or can be difficult to bend. On the other hand, such a socket must be rigidly fastened on the vehicle given the number of connection/disconnection cycles of a complementary connector of a cable that said socket will experience over the course of the life of such a vehicle.

### PRESENTATION OF THE INVENTION

The aim of the invention is to provide a charging socket support that overcomes the above disadvantages. Furthermore, the invention allows optimal positioning of the charging socket so as to satisfy perceived quality requirements.

To achieve this objective, the invention relates to a support for a hinge of an opening leaf, in particular of a hood, of a motor vehicle of electric or hybrid type that can be recharged via a charging socket, the support comprising a means for retaining such a charging socket with respect to the support.

The support may further comprise:
a means for centering the support that is intended to cooperate with a template for positioning the support,
a means for positioning such a charging socket with respect to the support.

The means for positioning such a charging socket with respect to the support may comprise a circular hole and an oblong hole.

The means for retaining such a charging socket may comprise orifices, in particular tapped orifices or orifices comprising nuts fastened to the rest of the support, in particular nuts welded to the rest of the support.

The support may be substantially U-shaped, the U comprising a first leg and a second leg.

The support may be obtained from a sheet, in particular a steel sheet, by at least bending and/or stamping.

The invention also relates to an arrangement comprising a cowl-side reinforcement and a support as defined above, the support being fastened on the cowl-side reinforcement and the support extending substantially in a vertical and longitudinal plane, the first leg extending downward and being arranged at the front and the second leg extending downward and being arranged at the rear.

The arrangement may comprise a front pillar, the second leg being able to be fastened on the front pillar.

The invention also relates to a body for a motor vehicle comprising an arrangement as defined above, a charging socket, a fender and a bowl fastened on the fender, the bowl comprising a passage opening for the charging socket, the charging socket being centered or substantially centered with respect to the opening in the bowl.

The invention also relates to a motor vehicle comprising a body as defined above, or an arrangement as defined above, or a support as defined above.

The invention also relates to a method for assembling a body as defined above, the method comprising:
a step of providing a body part of a vehicle of electric or hybrid type that can be recharged via a charging socket, the support, the charging socket, the fender and the bowl,
a step of fastening on the body part a template for positioning the support with respect to the body part,
a step of centering the support by the centering means,
a step of fastening the support by a means for retaining the support, optionally followed by a step of removing the positioning template,
a step of positioning the charging socket on the support by the positioning means,
a step of positioning and fastening the fender,
a step of fastening the charging socket by centering the charging socket with respect to the opening in the bowl, in particular by tightening the means for retaining the charging socket on the rest of the support.

### PRESENTATION OF THE FIGURES

These objects, features and advantages of the present invention will be explained in detail in the following description of an embodiment and of a mode of executing a method that is given in a nonlimiting manner in relation to the appended figures, in which:

FIG. 1 is a schematic view of a vehicle according to one embodiment.

FIG. 2 is a partial view of a body of the vehicle according to one embodiment.

FIG. 3 is a detail view of a bowl and of a charging socket according to one embodiment.

FIG. 4 is a view of an arrangement according to one embodiment.

FIG. 5 is a front view of a support according to one embodiment.

FIG. 6 is a perspective view of the support according to the embodiment.

### DETAILED DESCRIPTION

The direction in which a motor vehicle moves in a straight line is defined as being the longitudinal direction X. By convention, the direction perpendicular to the longitudinal direction, situated in a plane parallel to the ground, is termed transverse direction Y. The third direction, perpendicular to the other two, is termed vertical direction Z. Thus, use is made of a direct reference frame XYZ in which X is the longitudinal direction in the front-rear direction of the vehicle, that is to say directed toward the rear, Y is the transverse direction directed toward the right, and Z is the vertical direction directed upward. The front direction corresponds to the direction in which the motor vehicle customarily moves in the longitudinal direction and is opposite to the rear direction.

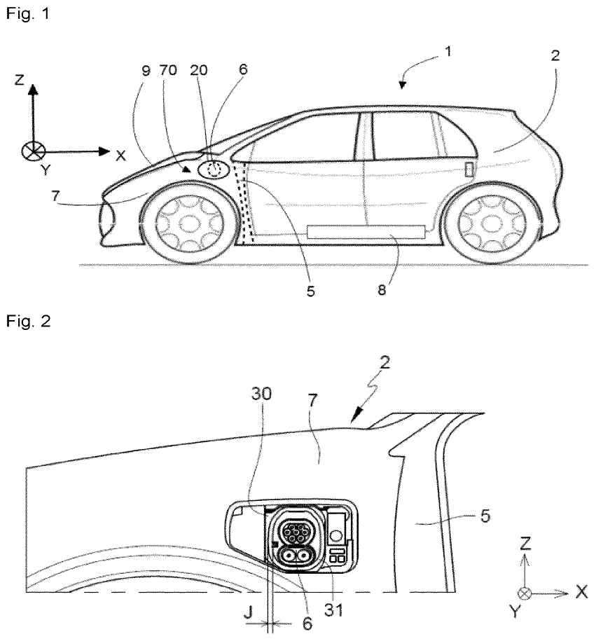

FIG. 1 schematically illustrates a vehicle 1, in particular a motor vehicle, according to one embodiment. The vehicle is of electric type or of rechargeable hybrid type. Thus, the vehicle comprises an electrical energy storage means 8, preferably a battery, for storing the electrical energy used to haul and/or propel the vehicle 1. The vehicle 1 comprises a body 2.

As illustrated in FIGS. 1 and 2, the body 2 comprises an electrical energy charging or recharging socket 6. As illustrated in FIGS. 1 and 4, the vehicle 1 or the body 2 comprises a hood 9 arranged at the front of the vehicle. The vehicle 1, or the body 2, further comprises a hinge 4 for the hood 9, arranged on the left, as illustrated in FIG. 4. Preferably, the vehicle 1, or the body 2, comprises another hinge for the hood 9, arranged on the right.

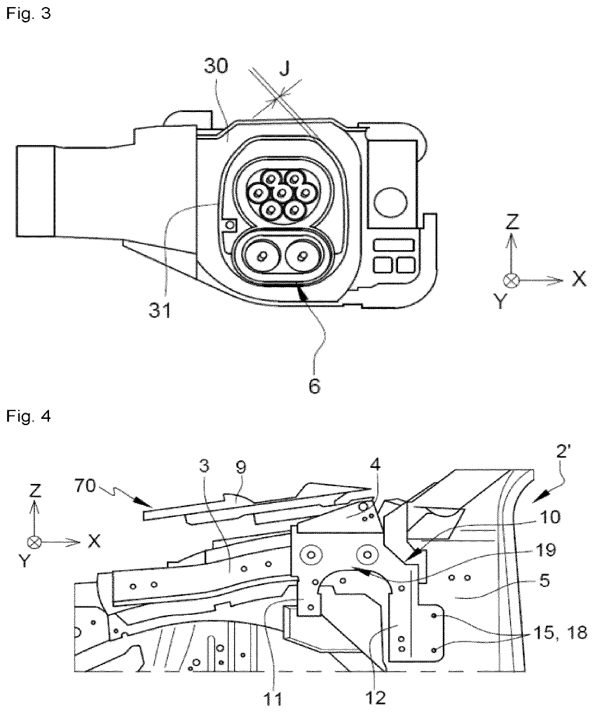

The body 2 further comprises a fender 7. The fender 7 is a front fender, for example a left front fender as illustrated in FIGS. 1 and 2. The body 2 further comprises a bowl 30 intended to surround the charging socket. The bowl 30 is fastened on or at the fender 7. As illustrated in FIGS. 2 and 3, the bowl 30 comprises a passage opening 31 for the charging socket 6. Preferably, a cover 20 conceals the charging socket 6 and the bowl 30 when the charging socket is not used.

The vehicle 1, or the body 2, also comprises an arrangement 70 illustrated in FIG. 4.

The arrangement 70 comprises a cowl-side reinforcement 3 on the left side in the case of a fender 7 on the left side, as illustrated.

Preferably, the arrangement 70 further comprises a front pillar 5. The front pillar 5 is arranged on the left side, the fender 7 being on the left side.

Of course, if it is desired to install the charging socket on the right side, at the right front wing, the cowl-side reinforcement, the front pillar and the hinge are those on the right side of the vehicle.

The vehicle, or the arrangement 70, further comprises a support 10.

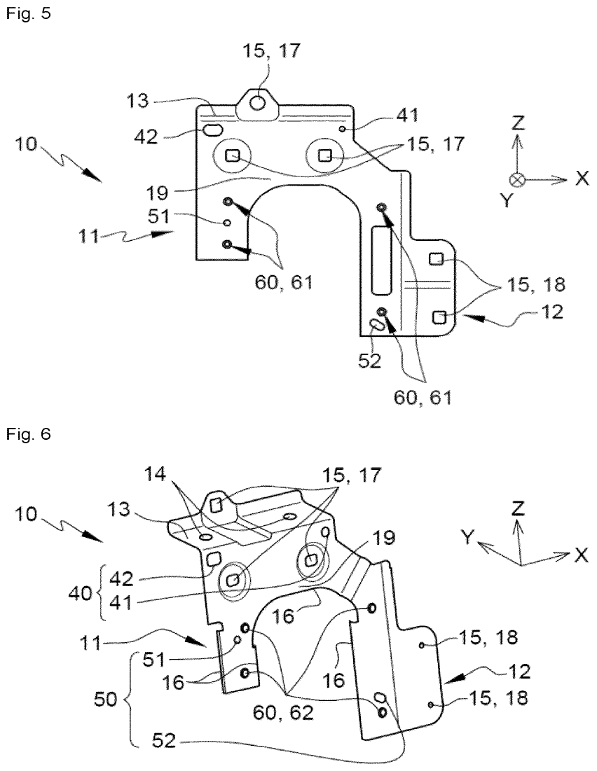

It should be noted that the support 10 is intended to receive the hinge 4 of the hood 9. For example, as illustrated in FIGS. 5 and 6, the support comprises an upper part 13, which is preferably planar or substantially planar and extends in a longitudinal and transverse plane or substantially in a longitudinal and transverse plane. The hinge 4 is for example fastened on the upper part 13, for example via a screw-nut-type means. Preferably, two tapped holes 14 are formed at the upper part 13 so as to cooperate with two screws passing through holes formed in the hinge 4.

Advantageously, the support 10 is obtained by bending a sheet, for example a precut sheet. For example, the support is obtained directly, or complementarily, by stamping a sheet. Preferably, the sheet is made of steel. The thickness of the sheet is for example between 1 mm and 3 mm, preferably of the order of 2 mm. Advantageously, in particular for the purpose of increasing the rigidity, the support 10 comprises one or more turned-over edges 16.

As illustrated in FIGS. 4 to 6, the support has a general U shape, the two branches or legs of the U extending downward once mounted on the body. In other words, the support 10 is substantially U-shaped, the U comprising a first leg 11 and a second leg 12. More precisely, the support 10 comprises a retaining means 15 for fastening it on the cowl-side reinforcement 3. The retaining means 15 comprises for example holes or orifices 17 formed in the support 10, for example in the top part, for example numbering three as illustrated in FIGS. 5 and 6. For example, the holes 17 have a square shape. Advantageously, the retaining means 15 makes it possible to fasten the support on the front pillar 5. The retaining means 15 comprises for example holes or orifices 18 formed in the support 10, for example on the second leg 12, for example numbering two as illustrated in FIGS. 5 and 6. For example, the holes 18 have a square shape. Thus, screws, or bolts, or rivets, may cooperate with these holes 17, 18 and the cowl-side reinforcement 3 and/or the front pillar 5 in order to retain the support 10. Thus, for example, nuts or tapped holes are provided on or at the cowl-side reinforcement and/or the front pillar.

It should be noted that the first leg 11 extends downward, as specified above, and is arranged at the front. The second leg 12 also extends downward and is arranged at the rear. In other words, preferably, the first leg 11 is in front of the second leg 12. Preferably, the first leg 11 and the second leg 12 extend substantially in one and the same vertical and longitudinal plane. Preferably, the support 10 comprises a junction part 19 between the first leg 11 and the second leg 12 that extends in the same vertical and longitudinal plane.

The support 10 further comprises a means 60 for retaining the charging socket 6 with respect to the support 10. In the embodiment illustrated, the retaining means 60 comprises orifices 61. Advantageously, the retaining means 60 comprises nuts 62 attached and fastened, for example welded, rest to the of the support 10. Alternatively, the orifices 61 are tapped in the support. Preferably, two holes 61 and/or nuts 62 are provided in the first leg 11, and two holes 61 and/or nuts 62 are provided in the second leg 12. Preferably, the two holes and/or nuts of each leg are spaced as far apart as possible so as to promote optimal retention of the charging socket 6 on the support 10. Preferably, the four holes and/or nuts are spaced as far apart as possible so as to promote optimal retention of the charging socket 6 on the support 10. Of course, fewer holes and/or nuts, or more holes and/or nuts, or even another system for fastening the socket on the support may be provided.

The support 10 further comprises a means 50 for positioning the charging socket 6 with respect to the support 10. In the embodiment illustrated, the positioning means 50 comprises a circular hole 51 and an oblong hole 52. Preferably, one hole is formed in the first leg 11 and the other hole is formed in the second leg 12. Advantageously, the holes 51, 52 are spaced as far apart as possible so as to promote a high degree of precision for positioning the socket with respect to the support.

The support 10 further comprises a means 40 for centering the support 10 that is intended to cooperate with a template for positioning the support 10 with respect to a body part 2′. In the embodiment illustrated, the centering means 40 comprises a circular hole 41 and an oblong hole 42 or a buttonhole slot that are intended to control the positioning by the template. The holes 41, 42 are formed in the junction part 19. By virtue of these holes 41, 42 cooperating with the template, the support is positioned precisely in the longitudinal direction and in the vertical direction.

A mode of executing a method for assembling the body 2 will now be described.

What is involved first of all is a step of providing a body part 2′ of a vehicle of electric or hybrid type that can be recharged via a charging socket 6. The support 10, the charging socket 6, the fender 7 and the bowl 30 are also provided. It should be noted that, preferably, the body part 2′ already comprises the front pillar 5 and/or the cowl-side reinforcement 3. Preferably, the bowl 30 is already fastened facing, or on, the fender 7.

This is followed by a step of fastening a positioning template (not illustrated) on the body part 2′. For example, the positioning template is fastened on the front pillar 5 and/or on another element arranged further to the front of the body part 2′.

This is followed by a step of centering or guiding the support 10 via the centering means 40. Thus, the holes 41, 42 are used for centering and positioning the support with respect to the positioning template. It will be recalled that, preferably, one hole is circular and the other hole is oblong.

The next step is a step for fastening the support 10 by the means 15 for retaining the support 10. More precisely, the orifices 17 are used to fasten the support on the cowl-side reinforcement 3, for example via screws or bolts or rivets, and the orifices 18 are used to fasten the support on the front pillar 5, for example via screws or bolts or rivets.

Alternatively, the support 10 is welded to the cowl-side reinforcement 3 and/or to the front pillar 5.

Optionally, a step of removing the positioning template is carried out.

This is followed by a step of positioning the charging socket 6 on, or facing, the support 10 by the positioning means 50. It will be recalled that, preferably, the positioning means 50 comprises the circular hole 51 and the oblong hole 52 widely spaced apart from one another. For example, screws or pins or rods, with or without shoulders, which are fastened temporarily or otherwise on the charging socket 6 or on the support 10, cooperate with the holes 51, 52 so as to position the socket with respect to the support.

This is followed by a step of positioning and fastening the fender 7 on the body part 2′. It will be recalled that, preferably, the bowl 30 is already fastened on the fender 7.

This is followed by a step of fastening the charging socket 6 by centering, or after having centered, the charging socket 6 with respect to the opening 31 in the bowl 30. What is meant by centered is that a clearance J surrounding the socket, that is to say between the socket 6 and the opening 31 in the bowl 30, is constant or substantially constant (FIGS. 2 and 3). The clearance J is for example between 1 mm and 5 mm. This step is preferably carried out by tightening the means 60 for retaining the charging socket 6 on the rest of the support 10. Thus, preferably, the tapped holes or nuts 62 arranged on the legs 11, 12 of the support 10 cooperate with screws passing through the charging socket 6. This fastening step is therefore carried out by tightening such screws.

The solution simplifies the installation of a charging socket on a vehicle, in particular at a front fender. Thus, although the charging socket is bulky and/or requires space behind it for the passage of electrical cabling which has a considerable cross section and/or may be difficult to bend, the support 10 makes it possible for the charging socket to be received, positioned and retained in a rigid, reliable and durable manner. Thus, in spite of the loading on the charging socket 6 associated with the number of connection/disconnection cycles of a complementary connector of an electrical supply cable, the charging socket 6 remains correctly positioned over the whole of the service life of the vehicle. The rigidity and/or the stiffness offered by the support 10 avoids any, even slight, play and/or movement of the charging socket during the connection/disconnection of the supply cable to or from the socket, thereby contributing to a high perceived quality of the vehicle by the users of such a vehicle. It should be noted that this rigidity is in particular provided by the presence of turned-over edges 16 at edge regions of the first leg 11 and/or at edge regions of the second leg 12 and/or at an edge region of the junction part 19 between the two legs 11, 12. Alternatively, or in addition, stamped features may be provided so as to contribute to the desired rigidity and/or stiffness.

It will be recalled that the support 10 also serves to retain the hinge 4 of the hood 9. In other words, the support 10 provides the support function for the hinge 4 and the support function for the charging socket 6. As a result, the number of “links” in the chain of dimensions is reduced, this being in spite of the lack of space at this level of the body. Specifically, for example, the chain of dimensions passes through the charging socket 6, then through the support 10 for the hinge 4 and the charging socket 6, then through a template for attaching fittings to or fixing the position of the hinge support and a support for the fender 7, then through the support for the fender 7, and finally through the fender 7. Given that a common template is put in place, the solution provides positioning coherence between the support for the hinge and the charging socket and the fender support.

This reduction in the chain of dimensions contributes to improving the centering of the charging socket 6 with respect to the fender 7, in particular by dispensing with a template link for the cowl-side reinforcement 3.

Furthermore, the solution does not impact the other elements, such as the support for the fender 7, which remains unchanged. Moreover, the solution does not require the complex and costly creation of a new template.

In summary, the support function of the charging socket 6 is achieved by the downward extension of a hinge support at the front (first leg 11) and by the downward and rearward extension of the hinge support (second leg 12) so as to be fastened on the structure of the body, in this instance on the front pillar 5.

As stated above, for example four holes 61 and/or nuts 62 contribute to the fastening and positional retention of the charging socket 6. For example, two holes 51, 52 make it possible to control the positioning of the charging socket 6 with respect to the support 10.

By virtue of the solution, although the bowl 30 is supported by the fender 7 and the support 10 for the charging socket is supported by the body, the dispersion between the charging socket 6 and the opening 31 in the bowl, and therefore between the socket 6 and the fender 7, is controlled. In other words, the finishing clearance J between the socket 6 and the opening 31 in the bowl 30 which the user sees is constant. The perceived quality is therefore satisfactory.

Furthermore, the solution allows a reduction in the number of parts (a single support for two functions, a single template), which represents a gain in terms of logistics and/or storage and/or handling, and of course in terms of cost.

Finally, the solution is particularly compact. It is inexpensive since it requires little material and therefore offers a saving in terms of mass.

Note that the solution according to the invention therefore achieves the desired objective of simplifying the installation of a charging socket on a rechargeable electric or hybrid vehicle and has the following advantages:
it is economical and employs customary manufacturing methods such as cutting, and/or bending, and/or stamping of sheet,
it may be used on all ranges of vehicles, even those having only little space in front of the front pillar and/or a hood extending toward the front over a small length in the longitudinal direction.

1-11. (canceled)

12. A support for a hinge of an opening leaf of an electric or hybrid motor vehicle that can be recharged via a charging socket, comprising:
means for retaining the charging socket with respect to the support.

13. The support as claimed in claim 12, wherein the opening leaf is a hood of the motor vehicle.

14. The support as claimed in claim 12, further comprising:
means for centering the support that is configured to cooperate with a template for positioning the support; and
means for positioning the charging socket with respect to the support.

15. The support as claimed in claim 14, wherein the means for positioning the charging socket with respect to the support comprises a circular hole and an oblong hole.

16. The support as claimed in claim 12, wherein the means for retaining the charging socket comprises orifices.

17. The support as claimed in claim 16, wherein the orifices are tapped orifices or orifices comprising nuts fastened to the rest of the support.

18. The support as claimed in claim 17, wherein the nuts are welded to the rest of the support.

19. The support as claimed in claim 12, wherein the support is substantially U-shaped, the U comprising a first leg and a second leg.

20. The support as claimed in claim 12, wherein the support is obtained from a sheet by at least bending and/or stamping.

21. The support as claimed in claim 20, wherein the sheet is a steel sheet.

22. An arrangement comprising:
a cowl-side reinforcement; and
the support as claimed in claim 19,
wherein the support is fastened on the cowl-side reinforcement, and the support extends substantially in a vertical and longitudinal plane, the first leg extending downward and being arranged at a front and the second leg extending downward and being arranged at a rear.

23. The arrangement as claimed in claim 22, further comprising a front pillar, wherein the second leg is fastened on the front pillar.

24. A body for a motor vehicle, comprising:
the arrangement as claimed in claim 22;
a charging socket;
a fender; and
a bowl fastened on the fender, the bowl comprising a passage opening for the charging socket, the charging socket being centered or substantially centered with respect to the opening in the bowl.

25. A motor vehicle, comprising
the body as claimed in claim 24.

26. A method for assembling the body as claimed in claim 24, comprising:
providing a body part of an electric or hybrid vehicle that is configured to be recharged via a charging socket, the support, the charging socket, the fender, and the bowl;
fastening on the body part a template for positioning the support with respect to the body part;
centering the support by a centering means;
fastening the support by a means for retaining the support;
positioning the charging socket on the support by a positioning means;
positioning and fastening the fender; and
fastening the charging socket by centering the charging socket with respect to the opening in the bowl.

27. The method as claimed in claim 26, wherein the fastening the charging socket includes tightening the means for retaining the charging socket on the rest of the support.

28. The method as claimed in claim 26, wherein the fastening the support is followed by removing the positioning template.
